(19) United States
(12) Patent Application Publication
(10) Pub. No.: US 2013/0322497 A1
(43) Pub. Date: Dec. 5, 2013

(54) DATA TRANSMISSION/RECEPTION APPARATUS IN DATA COMMUNICATION SYSTEM

(71) Applicant: ELECTRONICS AND TELECOMMUNICATIONS RESEARCH IN, Daejon (KR)

(72) Inventors: Bong-Su KIM, Daejeon (KR); Min-Soo KANG, Daejeon (KR); Kwang-Seon KIM, Daejeon (KR); Woo-Jin BYUN, Daejeon (KR); Won-Hui LEE, Daejeon (KR)

(73) Assignee: ELECTRONICS AND TELECOMMUNICATIONS RESEARCH INSTITUTE, Daejon (KR)

(21) Appl. No.: 13/681,650

(22) Filed: Nov. 20, 2012

(30) Foreign Application Priority Data
Jun. 1, 2012 (KR) 10-2012-0059014

(51) Int. Cl. H04B 1/38

(52) U.S. Cl. CPC H04B 1/38
USPC 375/219

(57) ABSTRACT

A data transmission/reception apparatus in a data communication system includes a transmission/reception unit connected to a device within a board and configured to wirelessly transmit transmission data from the device within the board to another device placed in one of other boards outside the board or another device placed in the board and wirelessly receive reception data from the another device, wherein the transmission/reception unit transmits the transmission data and receives the reception data using millimeter wave bands.

### CROSS-REFERENCE TO RELATED APPLICATIONS

The present application claims priority of Korean Patent Application No. 10-2012-0059014, filed on Jun. 1, 2012, which is incorporated herein by reference in its entirety.

### BACKGROUND OF THE INVENTION

1. Field of the Invention

Exemplary embodiments of the present invention relate to a data communication system and, more particularly, to a data transmission/reception apparatus for communicating data between boards or between devices within a board.

2. Description of Related Art

As the amount of data to be processed in a variety of devices increases, there is a need for an increase of the processing speed for processing data internally. The variety of devices includes, for example, a computer, a notebook, a mobile phone, a tablet PC, a set-top box, a Portable Media Player (PMP), a game machine, and electric home appliances.

For example, the computer can include devices, such as a Central Processing Unit (CPU), Random Access Memory (RAM), a Hard Disk Drive (HDD), and a video card. The operating speed of the devices rapidly increases in line with an increase of computer performance. None the less, computer performance is reduced because the operating speed of the entire system does not keep up with the operating speed of the devices.

As described above, one of important factors in a reduction of the performance of the entire system may be related to an interface between the devices. For example, as the speed of a transmission line or parallel cable between devices on a board increases to a Gigabit level or higher, there are a variety of problems, such as a loss on the line, complicated cabling, and crosstalk.

### SUMMARY OF THE INVENTION

An embodiment of the present invention is directed to providing a data transmission/reception apparatus capable of preventing a reduction of performance due to an interface between the devices of a board in a data communication system.

Another embodiment of the present invention is directed to providing a data transmission/reception apparatus capable of transmitting data between the devices of a board stably.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a data transmission/reception apparatus in a data communication system includes a transmission/reception unit connected to a device within a board and configured to wirelessly transmit transmission data from the device within the board to another device placed in one of other boards outside the board or another device placed in the board and wirelessly receive reception data from the another device, wherein the transmission/reception unit transmits the transmission data and receives the reception data using millimeter wave bands

In accordance with another embodiment of the present invention, a data transmission/reception apparatus in a data communication system includes a transmission unit configured to wirelessly transmit transmission data outputted from a first device placed in a first board and a reception unit configured to wirelessly receive reception data inputted to the first device, wherein the transmission unit and the reception unit transmit and receive the transmission data and the reception data to and from one of a second device placed in a second board different from the first board and a third device placed in the first board using frequency bands different from one of the second device and the third device.

### BRIEF DESCRIPTION OF THE DRAWINGS

FIG. 1 is a schematic diagram showing a movement of data within a common board or between boards.

FIG. 2 is a diagram showing data transmission/reception apparatuses in accordance with an embodiment of the present invention.

FIG. 3 is a diagram showing data transmission/reception apparatuses in accordance with another embodiment of the present invention.

FIG. 4 is an exemplary diagram showing frequency bands used between a bus communication apparatus and the data transmission/reception apparatuses shown in FIG. 3.

FIG. 5 is a diagram showing the structure of a data transmission/reception apparatus in accordance with an embodiment of the present invention.

FIG. 6 is a diagram showing the transmission/reception of data between data transmission/reception apparatuses in accordance with the present invention.

FIG. 7 is a diagram showing the transmission/reception of data between data transmission/reception apparatuses in accordance with another embodiment of the present invention.

FIG. 8 is a diagram showing an operation of designing the width of a dielectric waveguide according to the transition structure of the dielectric waveguide to a transmission line in accordance with the present invention.

FIG. 9 is a diagram showing an operation of designing the height of a dielectric waveguide according to the transition structure of the dielectric waveguide to a transmission line in accordance with the present invention.

FIG. 10 is a graph showing an S-parameter according to the transition structure of a dielectric waveguide to a transmission line in accordance with the present invention.

FIG. 11 is a diagram showing the transmission/reception of data between data transmission/reception apparatuses in accordance with yet another embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

The present invention proposes a data transmission/reception apparatus for preventing a reduction of performance due to an interface between the devices of a board. The data transmission/reception apparatus transmit and receive serial data between the devices. The data transmission/reception apparatus is connected to the devices and configured to transmit and receive data inputted to and outputted from the device. Accordingly, the data transmission/reception apparatus provides communication between devices placed within one board or provides communication between the devices of one board and the devices of the other board.

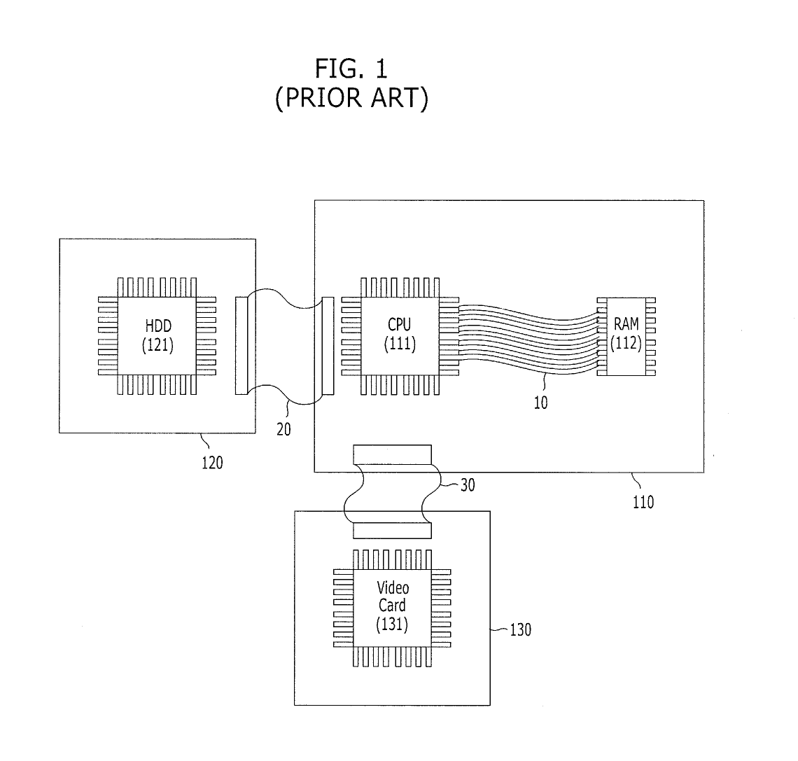

FIG. 1 is a schematic diagram showing a movement of data within a common board or between boards.

Referring to FIG. 1, equipment includes first to third boards 110, 120, and 130. A Central Processing Unit (CPU) 111a and Random Access Memory (RAM) 112 are placed in the first board 110. A Hard Disk Drive (HDD) 121 is placed in the second board 120. Furthermore, a video card 131 is placed in the third board 130.

The RAM 112 is placed in the first board 110 in which the CPU 111 is placed. The CPU 111 and the RAM 112 transmit and receive data each other through a transmission line 10 on the board 110.

The HDD 121 is placed in the second board 120 different from the first board 110.

The CPU 111 and the HDD 121 transmit and receive data each other through a first parallel cable 20.

Furthermore, the video card 131 is placed in the third board 130 different from the first board 110. The CPU 111 and the video card 131 transmit and receive data each other through a second parallel cable 30.

As described above, two or more devices can be placed in one board as in the first board 110, and one device can be placed in one board as in the second board 120 and the third board 130.

Hereinafter, data communication between devices placed in one board and the other board, respectively, is defined as inter-board communication, and data communication between devices placed in one board is defined as intra-board communication.

As described above, data between devices placed in one board is moved through the transmission line 10, and data between the devices placed in different boards is moved through the parallel cables 20 and 30. If a high frequency is used to move the data, characteristics, such as factors for determining the quality of a signal in the transmission line 10 and the parallel cables 20 and 30, for example, a loss of data and the degree of flatness are deteriorated.

For example, in order to transmit data of a 5 Gbps level, a transmission line or a parallel cable having a good characteristic of 5 GHz or higher in Direct Current (DC) is necessary. To this end, board having a good frequency characteristic may be used, but the board is expensive.

Furthermore, there is no delay between transmission lines, such as a parallel transmission line and a parallel cable, only when the transmission lines through which data is transmitted has the same length. It is, however, difficult to technically implement transmission lines having the same length as described above.

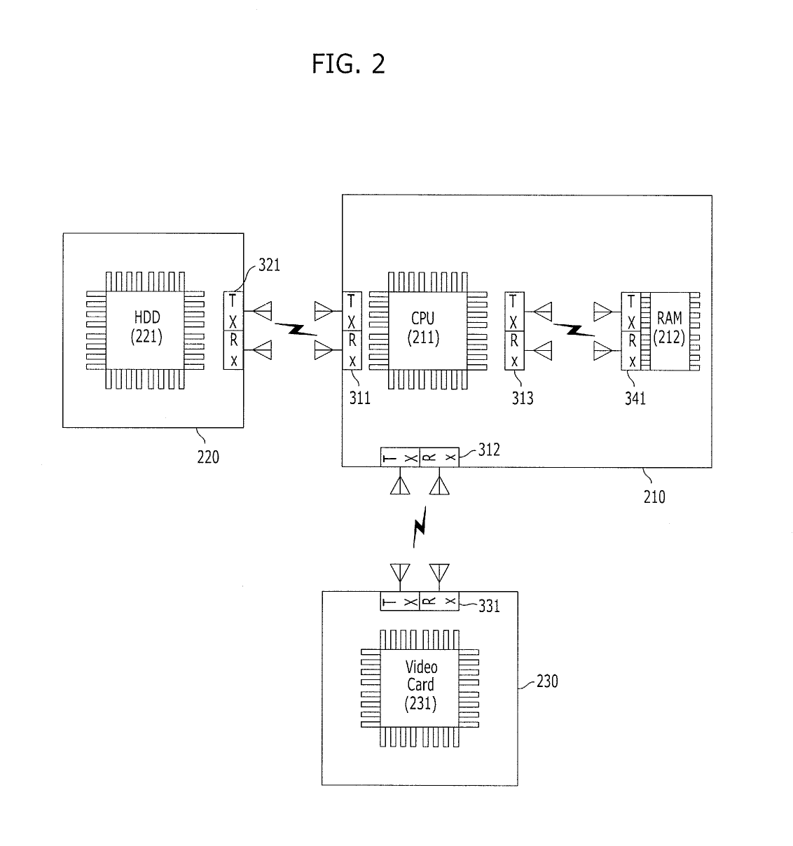

FIG. 2 is a diagram showing data transmission/reception apparatuses in accordance with an embodiment of the present invention.

Referring to FIG. 2, equipment includes first to third boards 210, 220, and 230. A CPU 211 and RAM 212 are placed in the first board 210. A HDD 221 is placed in the second board 220. Furthermore, a video card 231 is placed in the third board 230.

A first data transmission/reception apparatus 311, a second data transmission/reception apparatus 312, and a third data transmission/reception apparatus 313 are connected to the CPU 211.

A fourth data transmission/reception apparatus 321 is connected to the HDD 221.

A fifth data transmission/reception apparatus 331 is connected to the video card 231.

A sixth data transmission/reception apparatus 341 is connected to the RAM 212.

For example, the first data transmission/reception apparatus 311 communicates with the fourth data transmission/reception apparatus 321. The first data transmission/reception apparatus 311 transmits and receives data using a millimeter wave band. Here, the first data transmission/reception apparatus 311 converts parallel data into serial data and sends the serial data, and it also receives serial data and converts the received serial data into parallel data. Meanwhile, the first data transmission/reception apparatus 311 can further include transmission/reception antennas for transmitting and receiving data wirelessly.

As described above, data communication between the CPU 211 and the HDD 221 is performed by communication between the first data transmission/reception apparatus 311 and the fourth data transmission/reception apparatus 321.

Each of the second data transmission/reception apparatus 312 to the sixth data transmission/reception apparatus 341 can have a similar structure to the first data transmission/reception apparatus 311 and transmit and receive data using a millimeter wave band.

Consequently, data communication between the CPU 211 and the video card 231 is performed by communication between the second data transmission/reception apparatus 312 and the fifth data transmission/reception apparatus 331.

Furthermore, data communication between the CPU 211 and the RAM 212 is performed by communication between the third data transmission/reception apparatus 313 and the sixth data transmission/reception apparatus 341. Here, communication between the third data transmission/reception apparatus 313 and the sixth data transmission/reception apparatus 341 is intra-board communication and can be performed through wireless communication or dielectric communication using a dielectric substance.

First, in inter-board communication or intra-board communication, the data transmission/reception apparatuses 311, 312, 313, 321, 331, and 341 can use a frequency division method for allocating different frequency bands to different links for transmitting and receiving data. Here, the data transmission/reception apparatuses 311, 312, 313, 321, 331, and 341 can use filters for filtering their own frequency bands.

Second, the data transmission/reception apparatuses 311, 312, 313, 321, 331, and 341 can use a code division method for assigning predetermined codes in data transmission and separating the predetermined codes from each other in data reception. The code used in each of the data transmission/reception apparatuses 311, 312, 313, 321, 331, and 341 can be controlled to a proper length by taking a data transfer rate into consideration because the bandwidth of the code can be limited depending on the length.

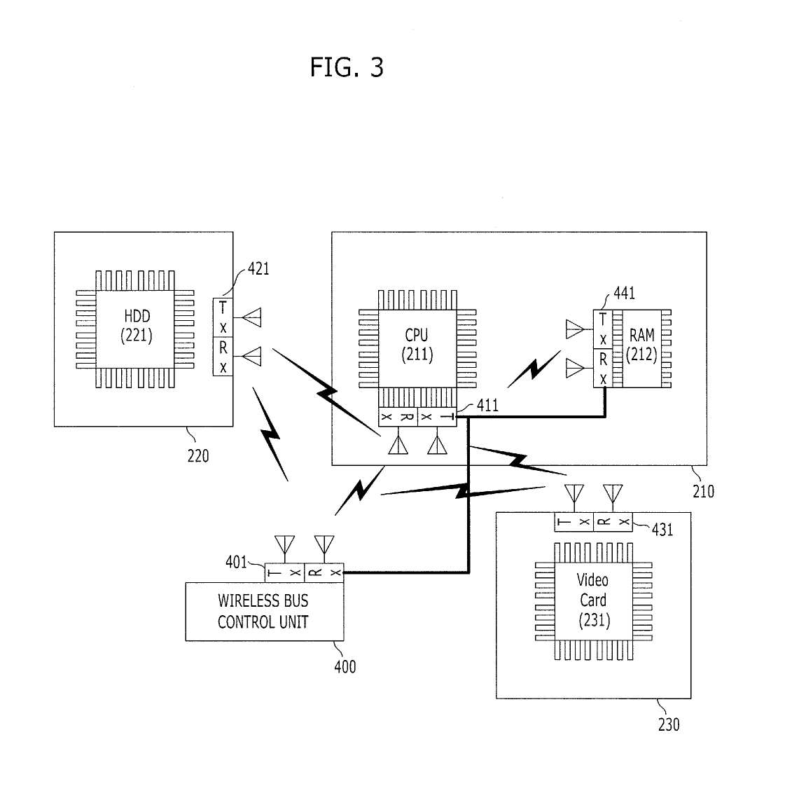

FIG. 3 is a diagram showing data transmission/reception apparatuses in accordance with another embodiment of the present invention.

Referring to FIG. 3, equipment includes first to third boards 210, 220, and 230. A CPU 211 and RAM 212 are placed in the first board 210. A HDD 221 is placed in the second board 220. Furthermore, a video card 231 is placed in the third board 230.

A first data transmission/reception apparatus 411 is connected to the CPU 211.

A second data transmission/reception apparatus 421 is connected to the HDD 221.

A third data transmission/reception apparatus 431 is connected to the video card 231.

A fourth data transmission/reception apparatus 441 is connected to the RAM 212.

The data transmission/reception apparatuses 411, 421, 431, and 441 are connected to respective devices, and each does not perform communication between devices as in FIG. 2. Each of the data transmission/reception apparatuses 411, 421, 431, and 441 can communicate with a plurality of wireless communication apparatuses connected to another device. For example, the first data transmission/reception apparatus 411 can communicate with the second data transmission/reception apparatus 421 to the fourth data transmission/reception apparatus 441.

The equipment further includes a wireless bus control unit 400 for controlling the data transmission/reception apparatuses 411, 421, 431, and 441.

A bus communication apparatus 401 for communicating with the data transmission/reception apparatuses 411, 421, 431, and 441 is connected to the wireless bus control unit 400. The wireless bus control unit 400 can communicate with the data transmission/reception apparatuses 411, 421, 431, and 441 using a predetermined common channel when communicating with the data transmission/reception apparatuses 411, 421, 431, and 441 using the bus communication apparatus 401.

The wireless bus control unit 400 analyzes a wireless environment by taking information, such as a bandwidth used, the amount of data transfer, and the distance between devices which are received through the data transmission/reception apparatuses 411, 421, 431, and 441, into consideration. The wireless bus control unit 400 can allocate a frequency band for data communication to a link that is used in each of the data transmission/reception apparatuses 411, 421, 431, and 441 based on the analyzed wireless environment.

The first data transmission/reception apparatus 411 and the fourth data transmission/reception apparatus 441 of the present invention use the same interface as that of wireless connection even when they are coupled by a wired line.

The wireless bus control unit 400 uses the same interface as that of wireless connection even when communication between devices within a board is performed through a wired line.

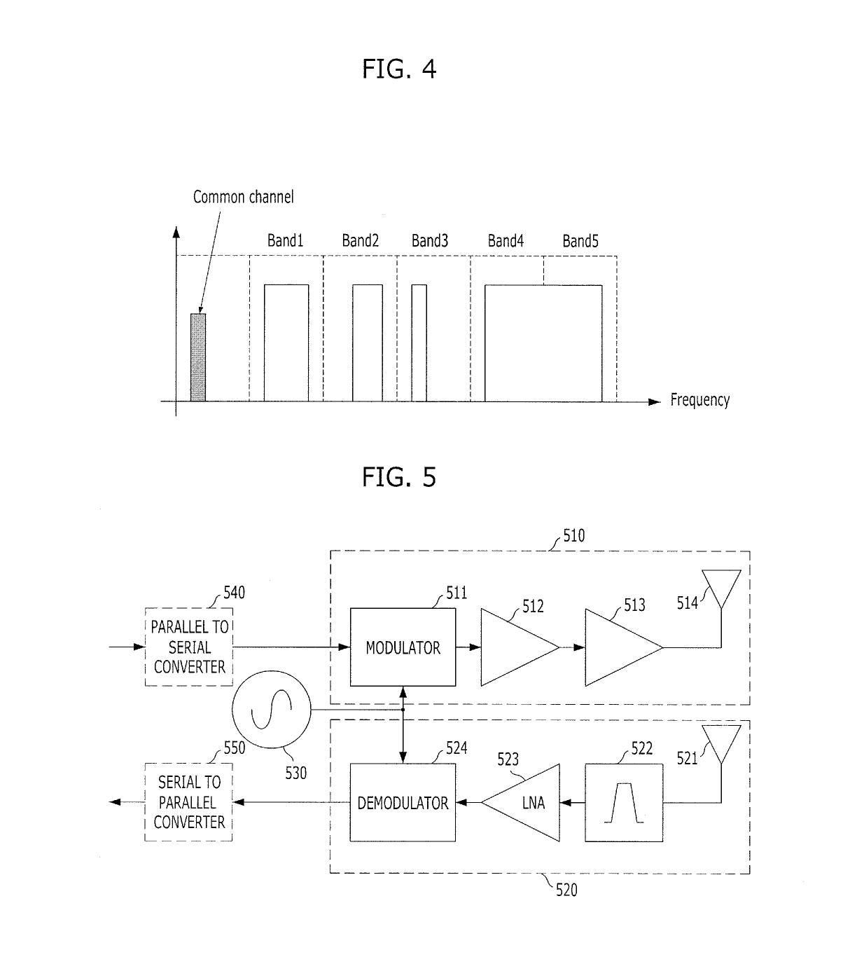

FIG. 4 is an exemplary diagram showing frequency bands used between the bus communication apparatus 401 and the data transmission/reception apparatuses shown in FIG. 3.

Referring to FIG. 4, a plurality of bandwidths is shown on the basis of the frequency. A common channel includes a frequency band used in communication between the bus communication apparatus 401 and the data transmission/reception apparatuses 411, 421, 431, and 441.

A first band Band1 to a fifth band Band5 are illustrated and can be allocated to respective links used in communication between the data transmission/reception apparatuses 411, 421, 431, and 441. Here, the wireless bus control unit 400 allocates different frequency bands to a link through which one data transmission/reception apparatus transmits data to the other data transmission/reception apparatus and a link through which one data transmission/reception apparatus receives data from the other data transmission/reception apparatus. The wireless bus control unit 400 allocates the frequency bands to the links so that the frequency bands do not overlap with each other in the links through which data is transmitted and received between the data transmission/reception apparatuses 411, 421, 431, and 441.

FIG. 5 is a diagram showing the structure of a data transmission/reception apparatus in accordance with an embodiment of the present invention.

Referring to FIG. 5, the data transmission/reception apparatus includes a transmission unit 510, a reception unit 520, and a Local Oscillator (LO) 530. The data transmission/reception apparatus can further include a parallel to serial converter 540 and a serial to parallel converter 550.

The LO 530 generates local oscillation signals for generating signals of frequency bands that are used in respective links through which data is transmitted and received.

The transmission unit 510 includes a modulator 511, a pre-amplifier 512, a post-amplifier 513, and a transmission antenna 514.

The modulator 511 receives the local oscillation signal from the LO 530. The modulator 511 modulates serial data, outputted from the parallel/serial converter 540, using the local oscillation signal. The modulator 511 outputs the modulated signal to the pre-amplifier 512.

The pre-amplifier 512 amplifies the modulated signal and outputs the pre-amplified signal to the post-amplifier 513.

The post-amplifier 513 amplifies the pre-amplified signal and outputs the post-amplified signal to the transmission antenna 514.

The transmission antenna 514 sends the post-amplified signal.

The reception unit 520 includes a reception antenna 521, a filter 522, a Low Noise Amplifier (LNA) 523, and a demodulator 524.

The reception antenna 521 receives a signal and outputs the received signal to the filter 522.

The filter 522 filters only a signal of a preset frequency band from the signal received through the reception antenna 521. The filter 522 outputs the filtered signal to the LNA 523.

The LNA 523 performs low-noise amplification processing on the signal received from the filter 522. Here, the LNA 523 amplifies a signal of a frequency band to be received from among received signals. The LNA 523 outputs the low-noise amplified signal to the demodulator 524.

The demodulator 524 receives a local oscillation signal from the LO 530. The demodulator 524 demodulates the low-noise amplified signal using the local oscillation signal. The demodulator 524 outputs demodulated reception data to the serial to parallel converter 550.

Meanwhile, the parallel to serial converter 540 converts parallel data, outputted from a device, into serial data, and the serial to parallel converter 550 converts serial data to be inputted to a device into parallel data. Accordingly, the parallel to serial converter 540 and the serial to parallel converter 550 processes parallel data that is inputted to and outputted from a device, and they can be included in the data transmission/reception apparatus.

As described above, the data communication apparatus of the present invention has a structure including the transceiver for transmitting and receiving data wirelessly and thus can transmit high-speed data stably.

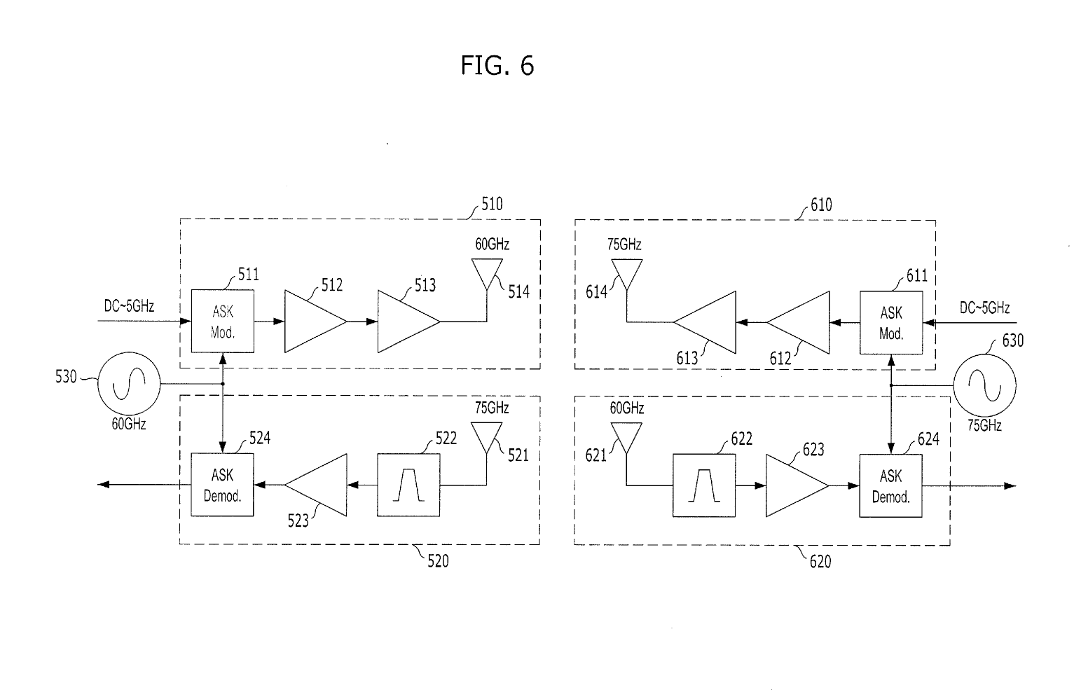

FIG. 6 is a diagram showing the transmission/reception of data between data transmission/reception apparatuses in accordance with the present invention.

Referring to FIG. 6, there are shown a first data transmission/reception apparatus connected to a first device and a second data transmission/reception apparatus connected to a second device. The first data transmission/reception apparatus transmits transmission data to the second data transmission/reception apparatus and receives reception data from the second data transmission/reception apparatus.

The first data transmission/reception apparatus includes a first transmission unit 510, a first reception unit 520, and a first LO 530. The first transmission unit 510 includes a first modulator 511, a first pre-amplifier 512, a first post-amplifier 513, and a first transmission antenna 514. Furthermore, the first reception unit 520 includes a first reception antenna 521, a first filter 522, a first LNA 523, and a first demodulator 524.

Furthermore, the second data transmission/reception apparatus includes a second transmission unit 610, a second reception unit 620, and a second LO 630. The second transmission unit 610 includes a second modulator 611, a second pre-amplifier 612, a second post-amplifier 613, and a second transmission antenna 614. Furthermore, the second reception unit 620 includes a second reception antenna 621, a second filter 622, a second LNA 623, and a second demodulator 624.

The structure of the first data transmission/reception apparatus has been described in detail with reference to FIG. 5, and thus a description thereof is omitted. Furthermore, the second data transmission/reception apparatus has a similar structure as the first data transmission/reception apparatus, and thus a description thereof is omitted.

Data of DC-5 GHz is inputted to the first transmission unit 510 and the second transmission unit 610. Here, the first transmission unit 510 communicates with the second reception unit 620 using a frequency of a 60 GHz band, and the second transmission unit 610 communicates with the first reception unit 520 using a frequency of a 75 GHz band.

To this end, the first data transmission/reception apparatus includes the first LO 530 for generating a local oscillation signal of a 60 GHz band, and the second data transmission/reception apparatus includes the second LO 630 for generating a local oscillation signal of a 75 GHz band.

An operation of transmitting data from the first transmission unit 510 to the second reception unit 620 is described below.

The first modulator 511 receives the local oscillation signal of a 60 GHz band. For example, the first modulator 511 performs Amplitude Shift Keying (ASK) modulation using the local oscillation signal of a 60 GHz band. Consequently, the first modulator 511 generates a signal having a center frequency of 60 GHz and a bandwidth of 10 GHz. The first modulator 511 outputs the ASK-modulated signal to the first pre-amplifier 512.

The first pre-amplifier 512 performs pre-amplification processing on the ASK-modulated signal and outputs the pre-amplified signal to the first post-amplifier 513.

The post-amplifier 513 performs post amplification processing on the pre-amplified signal and outputs a signal of a millimeter wave band according to the post amplification processing to the first transmission antenna 514.

The first transmission antenna 514 sends the signal of a millimeter wave band.

The second reception antenna 621 outputs a received signal to the second filter 622.

The second filter 622 filters the signal of a millimeter wave band that is outputted from the first transmission antenna 514. The second filter 622 outputs the filtered signal to the second LNA 623.

The second LNA 623 performs low-noise amplification processing on the filtered signal. The second LNA 623 outputs the low-noise amplified signal to the second demodulator 624.

The second demodulator 624 receives the local oscillation signal of a 75 GHz band. For example, the second demodulator 624 performs ASK demodulation processing corresponding to the ASK modulation processing of the first modulator 511. Here, the second demodulator 624 performs ASK demodulation on received data using the local oscillation signal of a 75 GHz band. Consequently, the second demodulator 624 can receive data transmitted by the first wireless transmitter 510.

In contrast, the second transmission unit 610 transmits the signal of a 75 GHz band to the first reception unit 520. An operation of transmitting the signal from the second transmission unit 610 to the first reception unit 520 is similar to the operation of transmitting and receiving data between the first transmission unit 510 and the second reception unit 620 other than a frequency band used. Accordingly, for the operation of transmitting and receiving data between the second transmission unit 610 and the first reception unit 520, reference can be made to the operation of transmitting and receiving data between the first transmission unit 510 and the second reception unit 620.

The first data transmission/reception apparatus and the second data transmission/reception apparatus modulate respective signals into signals of millimeter waves which have respective center frequencies of 60 GHz and 75 GHz and have respective bandwidths of 10 GHz and up-convert the signals by transmitting and receiving data using the ASK modulation methods. Here, each of the first and the second data transmission/reception apparatuses uses one LO and drives mixers within the modulator and the demodulator using data. Accordingly, the data transmission/reception apparatus proposed by the present invention can have a simple structure.

An interval between the frequencies generated by the LOs 530 and 630 has to be two times or more the transfer rate. Accordingly, a transfer rate of 5 Gbps has to have the interval of 10 GHz or more, and a transfer rate of 10 Gbps has to have the interval of 20 GHz or more. As a result, in the first data transmission/reception apparatus and the second data transmission/reception apparatus of the present invention, transmission and reception can be separated from each other by a difference between local oscillation frequencies because a single local oscillation frequency is used.

Accordingly, the data transmission/reception apparatus other than the antenna can be fabricated into a single chip (e.g., using a CMOS process) and can be cheaply supplied at the time of mass production.

The transmission antennas 514 and 614 and the reception antennas 521 and 621 of the first data transmission/reception apparatus and the second data transmission/reception apparatus can be simply embodied using antennas having omni-directivity because only a transmission distance shorter than that of a common transceiver is taken into consideration.

The data transmission/reception apparatuses shown in FIG. 6 can be used in communication between devices within boards or communication between devices within a board. Meanwhile, in intra-board communication, a transmission antenna and a reception antenna can be fabricated using a dielectric substrate having a good characteristic in a millimeter wave.

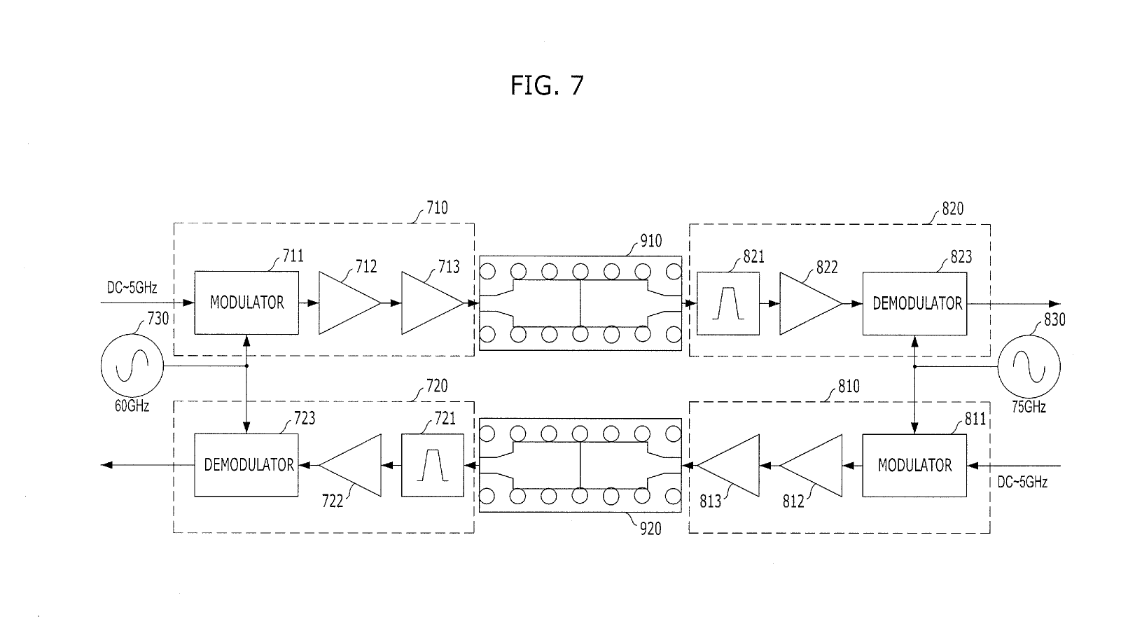

FIG. 7 is a diagram showing the transmission/reception of data between data transmission/reception apparatuses in accordance with another embodiment of the present invention.

Referring to FIG. 7, there are shown a third data transmission/reception apparatus connected to a third device and a fourth data transmission/reception apparatus connected to a fourth device. The third device and the fourth device can be placed in one board. The third data transmission/reception apparatus transmits data to the fourth data transmission/reception apparatus and receives data from the fourth data transmission/reception apparatus.

The third data transmission/reception apparatus includes a third transmission unit 710, a third reception unit 720, and a third LO 730. The third transmission unit 710 includes a third modulator 711, a third pre-amplifier 712, and a third post-amplifier 713. Furthermore, the third reception unit 720 includes a third filter 721, a third LNA 722, and a third demodulator 723.

Furthermore, the fourth data transmission/reception apparatus includes a fourth transmission unit 810, a fourth reception unit 820, and a fourth LO 830. The fourth transmission unit 810 includes a fourth modulator 811, a fourth pre-amplifier 812, and a fourth post-amplifier 813. Furthermore, the fourth reception unit 820 includes a fourth filter 821, a fourth LNA 822, and a fourth demodulator 823.

The data transmission/reception apparatus of FIG. 7 transmits and receives data using first and second dielectric waveguides 910 and 920 instead of transmission antennas and the reception antennas.

The first dielectric waveguide 910 transmits data from the third transmission unit 710 to the fourth reception unit 820, and the second dielectric waveguide 920 transmits data from the fourth transmission unit 810 to the third reception unit 720.

An operation of communicating data between the third data transmission/reception apparatus and the fourth data transmission/reception apparatus is similar to the previous operations except that the dielectric waveguides are used instead of antennas, and a detailed description thereof is omitted. Here, the transition structure of the dielectric waveguide to a transmission line is necessary for the communication between the data transmission/reception apparatuses.

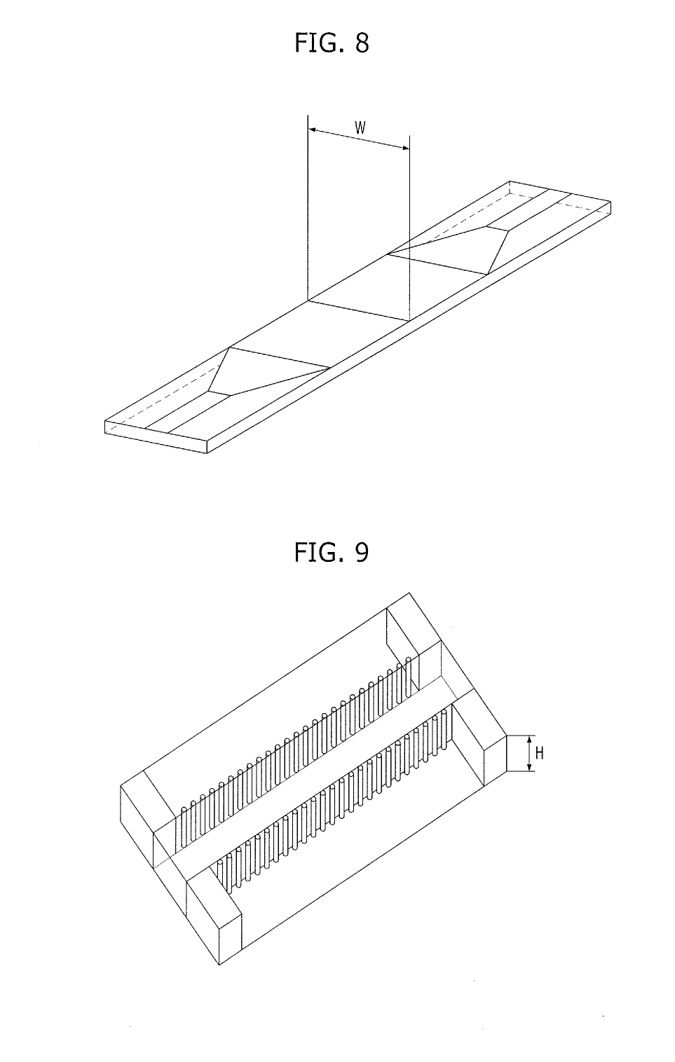

FIG. 8 is a diagram showing an operation of designing the width of the dielectric waveguide according to the transition structure of the dielectric waveguide to a transmission line in accordance with the present invention.

Referring to FIG. 8, the width W of the dielectric waveguide is controlled depending on the dielectric constant of a dielectric substance that forms the dielectric waveguide. Consequently, a dielectric waveguide suitable for a frequency can be selectively used in communication between data transmission/reception apparatuses.

FIG. 9 is a diagram showing an operation of designing the height of the dielectric waveguide according to the transition structure of the dielectric waveguide to a transmission line in accordance with the present invention.

Referring to FIG. 9, the dielectric waveguide has a height H. The height H of the dielectric waveguide does not have a great effect on the transfer characteristic of the dielectric waveguide. Accordingly, a dielectric waveguide having a height having the best performance in the dielectric waveguide transition structure can be used in communication between data transmission/reception apparatuses.

Furthermore, the walls of the dielectric waveguides can be densely disposed using a via process in order to improve performance.

FIGS. 8 and 9 show examples in which impedance matching is solved using a taper structure. As described above, performance can be improved by controlling the width and length of the taper structure.

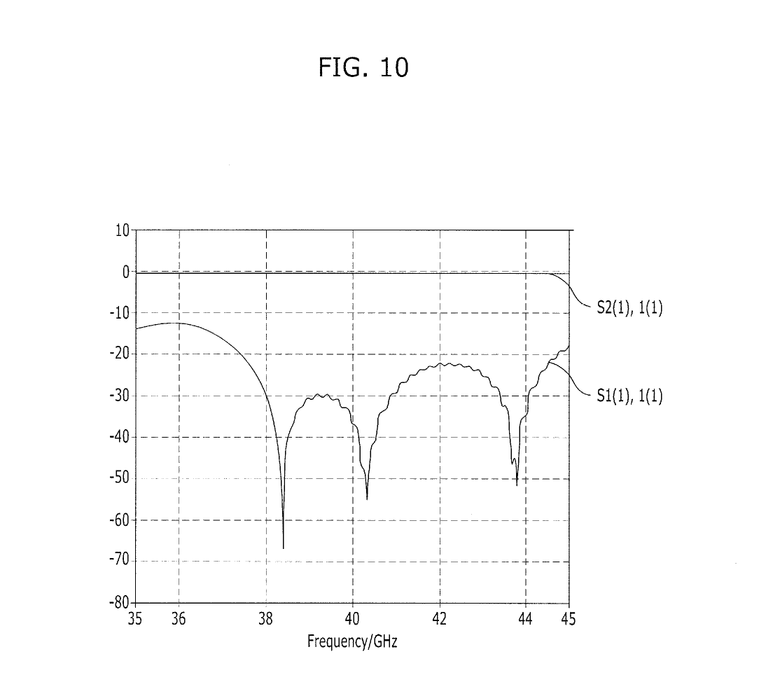

FIG. 10 is a graph showing an S-parameter according to the transition structure of a dielectric waveguide to a transmission line in accordance with the present invention.

Referring to FIG. 10, there is shown an S-parameter characteristic according to the use of the dielectric waveguide in frequency bands ranging from a 35 GHz band to a 45 GHz band. Consequently, data can be transmitted or received using the dielectric waveguide of a frequency band having optimum performance.

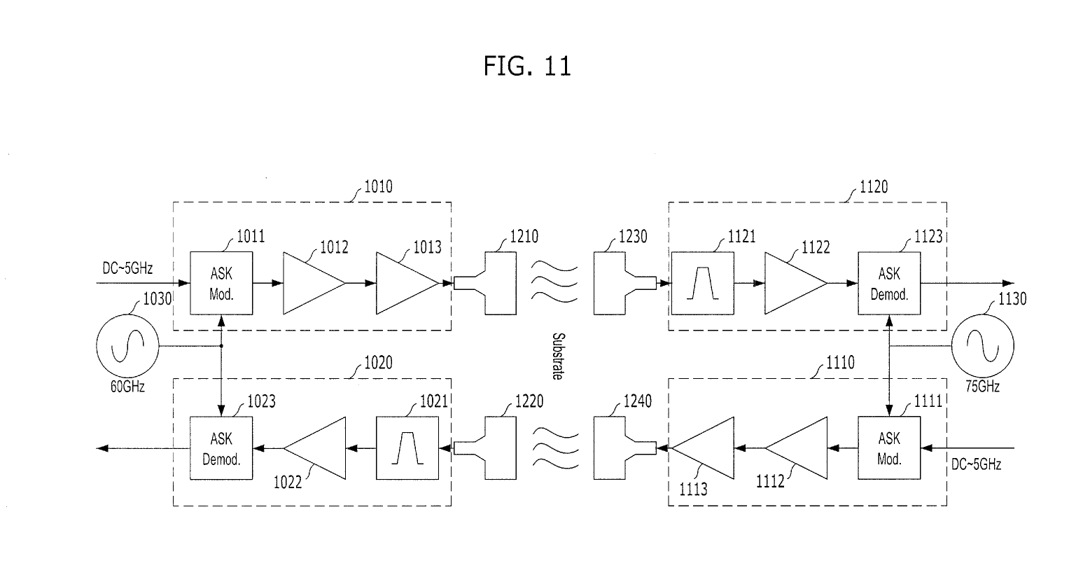

FIG. 11 is a diagram showing the transmission/reception of data between data transmission/reception apparatuses in accordance with yet another embodiment of the present invention.

Referring to FIG. 11, there are shown a fifth data transmission/reception apparatus connected to a fifth device and a sixth data transmission/reception apparatus connected to a sixth device. The fifth device and the sixth device can be placed in one board. The fifth data transmission/reception apparatus transmits data to the sixth data transmission/reception apparatus and receives data from the sixth data transmission/reception apparatus.

The fifth data transmission/reception apparatus includes a fifth transmission unit 1010, a fifth reception unit 1020, and a fifth LO 1030. The fifth transmission unit 1010 includes a fifth modulator 1011, a fifth pre-amplifier 1012, and a fifth post-amplifier 1013. Furthermore, the fifth reception unit 1020 includes a fifth filter 1021, a fifth LNA 1022, and a fifth demodulator 1023.

Furthermore, the sixth data transmission/reception apparatus includes a sixth transmission unit 1110, a sixth reception unit 1120, and a sixth LO 1130. The sixth transmission unit 1110 includes a sixth modulator 1111, a sixth pre-amplifier 1112, and a sixth post-amplifier 1113. Furthermore, the sixth reception unit 1120 includes a sixth filter 1121, a sixth LNA 1122, and a sixth demodulator 1123.

The data transmission/reception apparatuses of FIG. 11 transmit and receive data using first to fourth dielectric antennas 1210, 1220, 1230, and 1240 instead of transmission antennas and reception antennas.

The first dielectric antenna 1210 connected to the fifth transmission unit 1010 transmits data from the fifth transmission unit 1010 to the third dielectric antenna 1230 connected to the sixth reception unit 1120. Furthermore, the fourth dielectric antenna 1240 connected to the sixth transmission unit 1110 transmits data from the sixth transmission unit 1110 to the second dielectric antenna 1220 connected to the fifth reception unit 1020.

An operation of communicating data between the fifth data transmission/reception apparatus and the sixth data transmission/reception apparatus is similar to the previous operations except that the dielectric antennas 1210, 1220, 1230, and 1240 are used instead of wireless antennas, and a detailed description thereof is omitted. Here, the dielectric antennas 1210, 1220, 1230, and 1240 transmit and receive data through a substrate that forms the board.

Accordingly, the dielectric antennas 1210, 1220, 1230, and 1240 are connected to the substrate for communication between the fifth data transmission/reception apparatus and the sixth data transmission/reception apparatus. The dielectric antennas 1210, 1220, 1230, and 1240 are designed so that electric waves can be transferred through a dielectric substance, and they provide communication using the dielectric substance of the substrate. Accordingly, a substrate having a low dielectric substance loss value can provide communication between data transmission/reception apparatuses without using a dielectric waveguide. In the data transmission/reception apparatuses, the transmission units and the reception units can be placed anywhere where communication is possible on the substrate. Accordingly, there is an advantage in the deployment of devices in a board. In the data transmission/reception apparatuses using a dielectric substance, a counterpart transceiver can be placed at a desired position using a wave transfer characteristic of the dielectric substance itself.

As described above, the present invention proposes a data transmission/reception apparatus for providing communication between boards placed in devices or communication between devices placed in one board. To this end, the data transmission/reception apparatus for communication between devices can prevent a reduction of performance due to an interface between the devices because it uses a wide frequency band of a millimeter wave band which can transmit high-speed data stably. Furthermore, the data transmission/reception apparatus can increase data transmission/reception separation using different frequency bands in the transmission/reception of data between devices.

Furthermore, data transmission/reception separation can be increased using communication using a wireless method, communication using the dielectric waveguide, or communication using the substrate in communication between devices within a board.

The data transmission/reception apparatus can be reduced in size. Furthermore, the data transmission/reception apparatus can provide stable and cheap board communication because it has a simple modulation method and transceiver structure.

The data transmission/reception apparatus of the present invention can provide board communication in a variety of devices, such as a computer, a notebook, a mobile phone, a tablet PC, a set-top box, a PMP, a game machine, and electric home appliances.

In accordance with the present invention, a wireless transmission method is used on a board in order to stably transmit high-speed data between devices in a data communication system. Accordingly, a reduction of performance due to an interface between devices within a board can be prevented.

Furthermore, the present invention can improve the transmission speed because it transmits and receives data using a wide band, such as a millimeter wave band.

Furthermore, the present invention can transmit data between the devices of a board by separating transmission and reception frequencies from each other in order to improve transmission/reception separation.

While the present invention has been described with respect to the specific embodiments, it will be apparent to those skilled in the art that various changes and modifications may be made without departing from the spirit and scope of the invention as defined in the following claims.

What is claimed is:

1. A data transmission/reception apparatus in a data communication system, comprising:
a transmission/reception unit connected to a device within a board and configured to wirelessly transmit transmission data from the device within the board to another device placed in one of other boards outside the board or another device placed in the board and wirelessly receive reception data from the another device,
wherein the transmission/reception unit transmits the transmission data and receives the reception data using millimeter wave bands.

2. The data transmission/reception apparatus of claim 1, further comprising a Local Oscillator (LO) configured to provide a local oscillation signal for modulating the transmission data and demodulating the reception data to the transmission/reception unit.

3. The data transmission/reception apparatus of claim 1, wherein the transmission data and the reception data are serial data.

4. The data transmission/reception apparatus of claim 1, wherein a link through which the transmission data is transmitted and a link through which the reception data is received use different frequencies.

5. The data transmission/reception apparatus of claim 1, wherein a link through which the transmission data is transmitted and a link through which the reception data is received transmit and receive data using different codes so that the links are separated from the other links.

6. The data transmission/reception apparatus of claim 1, further comprising a dielectric waveguide configured to transmit and receive data between the device within the board and another device placed within the board.

7. The data transmission/reception apparatus of claim 1, further comprising a dielectric substance placed on a substrate and configured to transmit and receive data between the device within the board and another device placed within the board.

8. A data transmission/reception apparatus in a data communication system, comprising:
a transmission/reception unit connected to a device within a board and configured to wirelessly transmit transmission data from the device within the board to another device placed in one of other boards outside the board and wirelessly receive reception data from the another device; and
a dielectric communication unit configured to transmit and receive data between the device within the board and another device placed within the board,
wherein the transmission/reception unit transmits the transmission data and receives the reception data using millimeter wave bands.

9. The data transmission/reception apparatus of claim 8, wherein the dielectric communication unit is any one of a dielectric waveguide or a dielectric substance on the board.

10. A data transmission/reception apparatus in a data communication system, comprising:
a transmission unit configured to wirelessly transmit transmission data outputted from a first device placed in a first board; and
a reception unit configured to wirelessly receive reception data inputted to the first device,
wherein the transmission unit and the reception unit transmit and receive the transmission data and the reception data to and from one of a second device placed in a second board different from the first board and a third device placed in the first board using frequency bands different from one of the second device and the third device.

11. The data transmission/reception apparatus of claim 10, further comprising a Local Oscillator (LO) configured to provide a local oscillation signal for modulating the transmission data and demodulating the reception data to the transmission unit and the reception unit.

12. The data transmission/reception apparatus of claim 11, wherein the local oscillation signal separates transmission and reception from each other by an interval between a frequency of the transmission unit and a frequency of the reception unit.

13. The data transmission/reception apparatus of claim 10, wherein the different frequency bands are different from frequency bands used to transmit another transmission data and receive another reception data.

14. The data transmission/reception apparatus of claim 10, wherein the transmission unit and the reception unit transmit and receive the transmission data and the reception data using millimeter wave bands.

15. The data transmission/reception apparatus of claim 10, wherein:
the transmission unit and the reception unit use different codes when transmitting the transmission data and receiving the reception data, and
the different codes are different from codes used to transmit another transmission data and receive another reception data.

16. The data transmission/reception apparatus of claim 10, further comprising an external wireless bus control unit configured to communicate with the transmission unit and the reception unit using a common channel frequency band and allocate a frequency band for communication with one of the second device and the third device to the transmission unit and the reception unit.

17. The data transmission/reception apparatus of claim 10, wherein the transmission unit comprises:
a modulator configured to receive a local oscillation signal and generate an Amplitude Shift Keying (ASK)-modulated signal using the local oscillation signal;
a pre-amplifier configured to generate a pre-processed signal by performing pre-amplification processing on the modulation signal;
a post-amplifier configured to generate a post-processed signal by performing post amplification processing on the pre-processed signal; and
a transmission antenna configured to transmit the post-processed signal.

18. The data transmission/reception apparatus of claim 10, wherein the reception unit comprises:
a reception antenna configured to receive a signal;
a filter configured to filter a signal of a preset frequency band from the received signal;
a Low Noise Amplifier (LNA) configured to generate a low-noise amplification signal by performing low-noise amplification processing on the filtered signal; and
a demodulator configured to receive a local oscillation signal and demodulate the reception data from the low-noise amplification signal using an ASK modulation method.
